(19) United States
(12) Patent Application Publication
(10) Pub. No.: US 2013/0036474 A1
(43) Pub. Date: Feb. 7, 2013

(54) Method and Apparatus for Secure Data Representation Allowing Efficient Collection, Search and Retrieval

(71) Applicant: Debra Cook, Tinton Falls, NJ (US)

(72) Inventor: Debra Cook, Tinton Falls, NJ (US)

(73) Assignee: TELCORDIA TECHNOLOGIES, INC., Piscataway, NJ (US)

(21) Appl. No.: 13/366,867

(22) Filed: Feb. 6, 2012

Related U.S. Application Data
(60) Provisional application No. 61/440,448, filed on Feb. 8, 2011.

(51) Int. Cl. G06F 21/24

(52) U.S. Cl. 726/26

(57) ABSTRACT

A system and method for secure representation of data is presented. The method comprises setting a number of components, dividing original data into the set number of components using a function, storing the set number of components of divided data, determining a number of retrieved components, and using the function to retrieve the data from the retrieved components and to determine retrieved data. In one aspect, the function is XOR. In one aspect, when the number of retrieved components is less than the set number of components, the retrieved data is redacted data, and when the number of retrieved components is equal to the set number of components, the retrieved data is the original data.

### CROSS REFERENCE TO RELATED APPLICATIONS

The present invention claims the benefit of U.S. provisional patent application 61/440,448 filed Feb. 8, 2011, the entire contents and disclosure of which are incorporated herein by reference as if fully set forth herein.

### FIELD OF THE INVENTION

This invention relates generally to cryptography and in particular to securing data and allowing efficient collection, search and retrieval of the secured data.

### BACKGROUND OF THE INVENTION

In cryptography, symmetric key and public key algorithms protect data. However, traditional encryption that is used to protect data is often inefficient. For example, sharing secret algorithms allows retrieval of data given a subset of the secrets, but is feasible only on small data elements, such as keys, and not larger elements such as files and databases. Also, an encrypted file has to be decrypted from the beginning when using a block cipher and mode of encryption before it can be searched. It is not possible to begin the search in the middle of the file (assuming the data was not insecurely encrypted in ECB mode).

Thus there are solutions that solve individual problems in encryption technology but these solutions are too computationally intensive to be practical in reality and do not work together to collectively address usability or practical needs.

### SUMMARY OF THE INVENTION

The present invention solves the problems discussed above with respect to traditional encryption while also satisfying the practical needs of data collection, accessibility and search. The novel method protects data stored either as files or in a database while preventing unauthorized reading of the data and partial data retrieval should the systems storing the data become compromised. As an alternative to storing data in a single place in encrypted form, the data can be stored as a set of components which must be combined via a logical operation to retrieve the data. Hence searching on the hidden data becomes feasible, requiring less computational overhead than that of existing searchable encryption methods and without the need to augment the data with tags or keywords. The search methods can be enhanced to support privacy information retrieval (PIR). The sets of components can be defined in a manner such that specific subsets create redacted forms of the data.

A novel method for secure representation of data comprises setting a number of components, dividing original data into the set number of components using a function, storing the set number of components of divided data, determining a number of retrieved components and using the function to retrieve the data from the retrieved components and to determine retrieved data.

A novel system for secure representation of data comprises a processor and a module operable to set a number of components, divide original data into the set number of components using a function, store the set number of components of divided data, determine a number of retrieved components and use the function to retrieve the data from the retrieved components and to determine retrieved data.

In one aspect, the function is XOR. In one aspect, when the number of retrieved components is less than the set number of components, the retrieved data is redacted data, and when the number of retrieved components is equal to the set number of components, the retrieved data is the original data.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates one application of the invention in which either a redacted or non-redacted version of encrypted data is retrieved.

FIG. 2 illustrates a sample file stored as components in accordance with the present invention.

FIG. 3 illustrates retrieving a desired data in accordance with the present invention.

FIG. 4 illustrates determining the first byte of each component in an embodiment of the present invention.

FIG. 5 is a flow diagram for creating components in the inventive method.

FIG. 6 is a flow diagram for retrieving desired data in the inventive method.

### DETAILED DESCRIPTION

An inventive system and method for secure data representation allowing efficient collection, search and retrieval of data is presented. In the novel approach, data will be stored as n components such that a logical combination of the components recreates the data. Each subset of components up to some size k will be incomprehensible. Let G be the function that takes as input the components and combines them to create the data. G will combine the i^{th} byte of each component to obtain the i^{th} byte of the data. For example, a file may be stored as n files such that XORing the n files together recreates the original file.

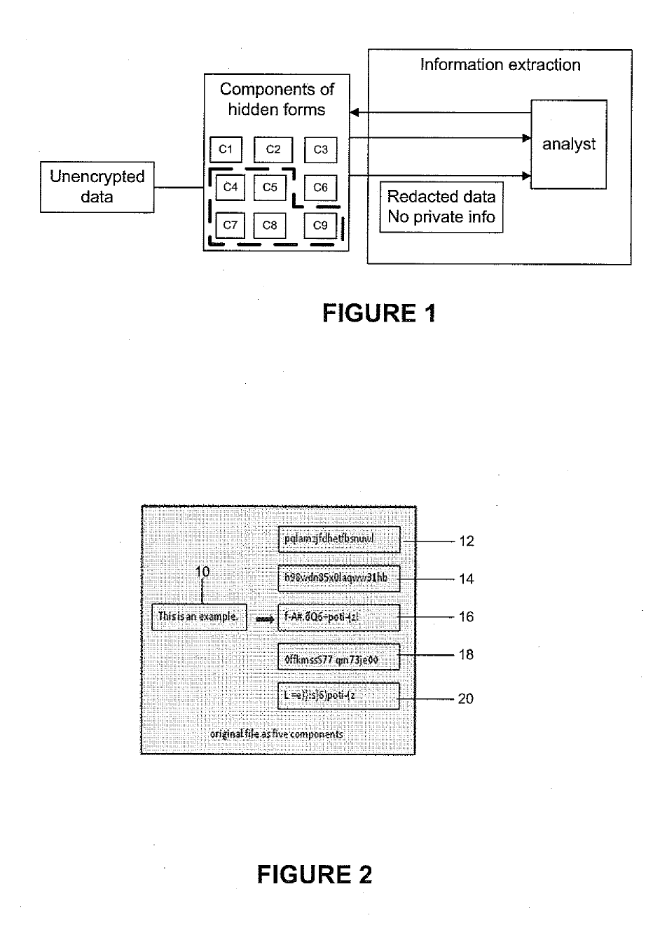

FIG. 1 illustrates one application of the invention in which either a redacted or non-redacted version of encrypted data is retrieved. FIG. 1 shows unencrypted data divided into nine components, C1 . . . C9. Queries are performed against all components. A subset of components, shown in the area in the dotted line, e.g., components C4, C5, C7, C8, C9, form a redacted version of the data. Accordingly, when an information extractor issues a query, the appropriate components are returned in a response to the query. If the information extractor is not restricted and/or the information is public, all of the components, e.g., components C1 . . . C9, are returned in the response. However, if the information extractor is restricted, for example if some of the information is private or requires authorization to obtain, only the non-private components are returned, resulting in a redacted response.

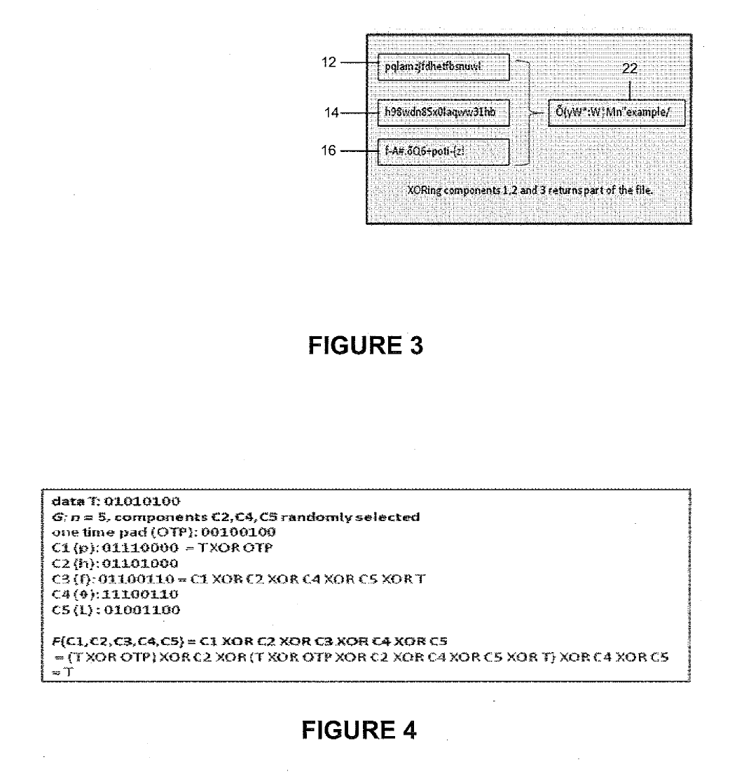

FIG. 2 shows a text file containing the single sentence 10 “This is an example”. The file is divided into n components 12, 14, 16, 18, 20, n=5, that allow part of the file to be retrieved from three of the components. The components may be the five lines shown, each stored in a separate file (unprintable byte values are indicated by a ⋄ and the fifth component ends in a space). FIG. 3 shows reproducing the original text. In this example, XORing the bytes of the five components produces the original text, and all five components are needed to reproduce all of the original text. If the 4th and 5th components are missing, the word example of the original text can still be obtained, as shown as component 22 of FIG. 3.

The components will be created by applying a function F to the data; determining candidate functions for F is feasible. One option, which was used to create the example in FIG. 2, is based on the concept of a one-time pad from cryptography and defining G to be the XOR of all the components. A one-time pad involves XORing data with random bits, which can be generated using an existing pseudo-random bit generator, such as a stream cipher. The first step in F in this case is to apply a one-time pad to the data. Let the result be the first component. This leaves n−1 components to be determined. For any byte of data requiring all n components to retrieve the byte, the i^{th} byte of each of n−2 of the remaining n−1 components is randomly selected. The i^{th} byte of the remaining component is the XOR of the i^{th} byte of each of the other components and the data.

FIG. 4 shows how the first byte of each component was created in the example from FIG. 2. In FIG. 4, the data “T” corresponds to the “T” from “This” in the example shown in FIG. 2. This first byte is determined as follows. For any byte requiring a subset of y of the n components to retrieve the data byte, the i^{th} byte of y components are faulted instead of n components in the same manner. The i^{th} byte of the remaining m=n−y components are formed by having m−1 bytes be random and the remaining one be the XOR of the m−1 bytes. This results in the subset of y bytes producing the original byte of data and the remaining m combining to be all zeroes. While F and G are inverses since G recreates the data F broke into components, there does not need to be a one to one correspondence between F and G. For example, if G is defined as the XOR of the components, more than one F can be defined to create the components in the example by altering which components have the i^{th} byte randomly selected for each i.

The process shown in FIG. 4 and described above is similar to the concept of visual cryptography applied to images but can take into consideration issues such as other data formats, searching, component storage and partial data retrieval. It serves an alternative to secret sharing and threshold methods, which are only feasible for small amounts of data, such as keys. The inventive method can address practical needs, such as searching on data and the capability to reveal parts of data (a built in redaction method allowing part of the data to be retrieved with a subset of the components). The algorithm can also be designed to allow partial data retrieval if a subset of the components are compromised.

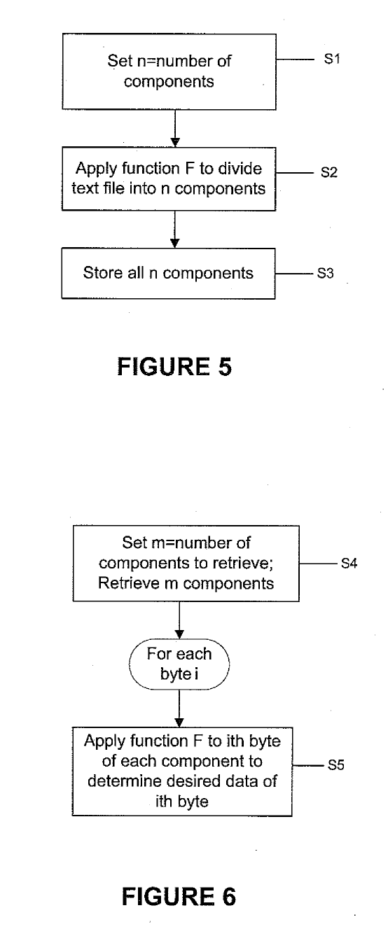

FIG. 5 is a flow diagram of creating the components. In step S1, the number of components, e.g., “n”, is established or set. In step S2, function F is applied to divide the text file into the “n” components. In step S3, all of the components are stored.

FIG. 6 is a flow diagram of retrieving the original text from the components. In step S4, the number of components to retrieve, e.g., “m”, is retrieved. Step S5 is performed for each byte i in each component. In step S5, apply function F to the ith byte of each component to determine the desired data of the 9-ith byte. When step S5 is performed for all bytes, the original text is retrieved if all components are retrieved. If the number of components to retrieve is not the total number of components, e.g., m<n, then a redacted version of the original text is retrieved when step S5 is performed for all bytes.

The novel method allows searching of the data without having to reveal all of the original contents at once and allows searching within a file without having to start from the beginning This is accomplished by applying F only on the segments of the components corresponding to the portion of the data to be searched, revealing one byte (or one bit) at a time and comparing it to the current byte in the search term to be matched. Revealed bytes can be discarded if they are not part of the match. Byte level masks can be applied to the bytes being combined to allow single bits to be checked to determine if the combined byte could potentially be a match before exposing the entire byte, preventing the need to have any portion of the original unencrypted data stored temporarily in memory unless it is part of the match. Search utilities can include flexibility in terms of how much data before and after a match on the search term is saved in order to display the results of the search in some context, such as displaying an entire line of a file containing a search term. In one embodiment, PIR can be incorporated into the method.

The search term itself can be hidden by breaking it into components in the same manner the data was broken into components, then checking where the result of F applied to the data components and the search term components is zeroes.

This method offers an advantage over stream ciphers and block ciphers. Data encrypted with a stream cipher requires recreating the key stream from the beginning. Depending on the mode of encryption used with a block cipher, the data may require decrypting from the beginning in order to perform a search. The inventive technique also avoids the need for using keywords and large computational overhead found in existing searchable encryption methods, which have so far been impractical.

The inventive technology enables efficient and secure collection of non-private information from data. In the case of email and social networking applications, the data (email, individuals' social network pages and communication history) typically contains private information and the application provider does not make such data available for searching. If the data is stored by the provider in the inventive form disclosed herein, a search for a word or phrase can be submitted against the data without requiring that any data, other than the search result, be provided to the entity requesting the search and without having to expose the data during the search. The application provider could also store the data such that a subset of the components provides a redacted form of the data that can be provided to outside entities.

Cross-domain security can be achieved. The redaction capability allows a subset of the components to provide a redacted form of the original data. An individual or entity (such as another system or application) can be given access to the subset of the data appropriate for its clearance level. A trivial example would be storing components as files on a system and defining group permissions such as a subset of the components needed to create a redacted version of the data is owned by a group corresponding to a certain clearance level. An entity accessing the data would not need a key to decrypt the data, but would instead acquire all the components to which it has read access and combine them to obtain the redacted copy.

In one aspect, the size of the data will be at least n times that of the original data, where n is the number of components. If the size of the data must be hidden, the size may be increased, such as by adding padding to files. Files can also be broken into smaller segments and the i^{th} segment stored as nᵢ components. In one aspect, a method for knowing what components need to be combined and the locations of the components may be required depending on the applicable and storage. While the use of groups permissions described earlier is one such method applicable if the entities accessing the data know where the data is stored, this may not be the case in all scenarios. Maintaining a list of the components requires the need to protect the list. The list is the “key” to “decrypting” the data and presents many of the same issues as key storage for encrypted data. An alternative to maintaining a list is to embed pointers to other components within components, which requires ensuring the pointers cannot be extracted by an adversary. However, the use of such pointers is not feasible if the location of components can change.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed:

1. A method for secure representation of data, comprising steps of:
setting a number of components;
dividing original data into the set number of components using a function;
storing the set number of components of divided data;
determining a number of retrieved components; and
using the function to retrieve the data from the retrieved components and to determine retrieved data.

2. The method according to claim 1, wherein the function is XOR.

3. The method according to claim 1, wherein when the number of retrieved components is less than the set number of components, the retrieved data is redacted data, and when the number of retrieved components is equal to the set number of components, the retrieved data is the original data.

4. A computer readable storage medium storing a program of instructions executable by a machine to perform a method for secure representation of data, comprising:
setting a number of components;
dividing original data into the set number of components using a function;
storing the set number of components of divided data;
determining a number of retrieved components; and
using the function to retrieve the data from the retrieved components and to determine retrieved data.

5. The program according to claim 4, wherein the function is XOR.

6. The program according to claim 4, wherein when the number of retrieved components is less than the set number of components, the retrieved data is redacted data, and when the number of retrieved components is equal to the set number of components, the retrieved data is the original data.

7. A system for secure representation of data, comprising:
a processor; and
a module operable to set a number of components, divide original data into the set number of components using a function, store the set number of components of divided data, determine a number of retrieved components and use the function to retrieve the data from the retrieved components and to determine retrieved data.

8. The system according to claim 7, wherein the function is XOR.

9. The system according to claim 7, wherein when the number of retrieved components is less than the set number of components, the retrieved data is redacted data, and when the number of retrieved components is equal to the set number of components, the retrieved data is the original data.
